(19) United States
(12) Patent Application Publication
(10) Pub. No.: US 2019/0318731 A1
(43) Pub. Date: Oct. 17, 2019

(54) Collaborative Transcription With Bidirectional Automatic Speech Recognition

(71) Applicant: Nuance Communications, Inc., Burlington, MA (US)

(72) Inventors: Uwe Helmut Jost, Groton, MA (US); Neeraj Deshmukh, Woburn, MA (US)

(21) Appl. No.: 15/951,719

(22) Filed: Apr. 12, 2018

(51) Int. Cl. G10L 15/197; G10L 15/05; G10L 15/22

(52) U.S. Cl. CPC G10L 15/197; G10L 15/22; G10L 15/05

(57) ABSTRACT

A method of performing bidirectional automatic speech recognition (ASR) using an external information source includes performing a precompute pass by pre-processing an utterance in a backward direction to generate pre-processing data stored in a data structure. In a run-time pass, ASR is performed on the utterance in a forward direction using the pre-processing data to generate a prediction list that has a given number of words in path probability order. A word prediction based on the prediction list is presented to an external information source to obtain a response confirming, selecting or correcting the word prediction. The word prediction based on the response and the prediction list are updated. Processing repeats until the end of the utterance is reached. The method outputs an automatic speech recognized form of the utterance based on the word prediction. Use of the external information source in an integrated manner improves current and future predictions.

### BACKGROUND

Speech-to-text transcription is used in many applications. The transcription is usually performed by a human agent. However, the use of human agents to transcribe voice data to text is costly, and sometimes the transcription quality is less than satisfactory. With significant advances in automatic speech recognition (ASR) and language modeling tools, machine-based solutions for speech-to-text transcription are becoming a reality. Such solutions may be used in combination with a human agent or separately.

Currently, ASR can be very quick and inexpensive but makes errors. A human transcriber can use more knowledge and is still more accurate (more robust) than a machine in many cases but is typically slow and expensive.

### SUMMARY

A method of performing bidirectional automatic speech recognition using an external information source includes performing a precompute pass by a) pre-processing an utterance in a backward direction from end to start of the utterance to generate pre-processing data stored in a data structure. The method further includes performing a run-time pass by b) performing automatic speech recognition on the utterance in a forward direction using the pre-processing data to generate a prediction list that has a given number of words in path probability order; c) (i) presenting a word prediction based on the prediction list to an external information source to obtain a response from the external information source to confirm, select, or correct the word prediction, (ii) updating the word prediction based on the response from the external information source, and (iii) updating the prediction list accordingly; and d) repeating b) and c) until the end of the utterance is reached; and outputting an automatic speech recognized form of the utterance based on the word prediction.

The external information source can be a human agent or may be a natural language understanding or artificial intelligence (AI) component. Other examples of external information sources include any kind of business backend system that can check if some input is consistent with other data. For example, an application aware of a user's contact list could establish that the most likely first name recognized is not in the contact list but a first name further down in the n-best list is, hence pick the n-best alternative.

In some embodiments, the word prediction includes n-best possible words.

An output of the method may be an automatic speech recognized form of the utterance, which can be a text transcript of the utterance. The output can be in a form other than text transcript, such as, for example, a word hypotheses graph. A word hypothesis graph is useful in cases where a less comprehensive external information source or a less comprehensive human correction is employed. If the external information source is a human agent who corrected the entire automatic speech recognized utterance, the method would know which single path is correct and employing a graph output would not be beneficial.

The method will also allow outputting word timings of the corrected text. Word timings are often useful, e.g., if one wants to use the transcript for navigating in a video or for close captioning. Automatic speech recognition can typically deliver word timings but the baseline approach of just correcting a transcript after automatic speech recognition would not deliver word timings (at best, it could preserve the timings from the original speech recognition pass but not for the new words). Similarly, a prior approach, described further below, could deliver the timings of the words available in the lattice but not of any new words.

The method can further include updating a model employed by the automatic speech recognition in the forward direction as a result of the response from the external information source.

Updating the model can include one or more of adding a word to a vocabulary, updating a lexical cache model, incrementally building a document specific language model from recognized text for interpolation with an original language model, or adapting acoustic model parameters using information gained by aligning a new word with audio data of the utterance.

Pre-processing the utterance in a backward direction can include performing automatic speech recognition on the utterance with a reverse language model.

The utterance can be divided into frames, and the data structure can include, for each frame of the utterance, a path score of a best path to the end of the utterance from the frame. For example, the data structure can include, for each word that ends in a given frame (e.g., word candidates from the reverse processing), (1) a combined score of acoustic model and language model scores for the best path to the end of the utterance from the frame, and (2) a minimum score of the combined acoustic model and language model scores over all words that end in the frame. The minimum score can be used as a basis for an estimate of the probability of a path for which there is no word stored in the data structure. The data structure can further include acoustic parameters.

After updating the word prediction, the automatic speech recognition in the forward direction can be performed from a starting point earlier in time, e.g., earlier in time than the word start of the word just predicted or corrected, and can be initially restricted to sequence that includes at least the just predicted or corrected word, e.g., the updated word prediction, or more words that have already been confirmed. For example, the corrected word is just aligned to the audio but the process may go back in time some more words. The starting point can be selected based on the start time of the first confirmed word in the sequence. After these initial words, the automatic speech recognition can recognize any word according to its normal model. Stated slightly differently, the method can go back one or more confirmed words to re-start recognition. These one or more words form the “sequence” of “initial words.” The recognition start time would be set to the first (in time) word in this sequence and then force the automatics speech recognition to recognize these words again.

The automatic speech recognition in the forward direction can be performed until ends of new words are hypothesized by the automatic speech recognition. The method can further include looking up the hypothesized word ends in the data structure to determine, for each of the word ends, whether the word end is found at a given frame in the data structure. If the word end is found at the frame in the data structure, the relevant scores are read from the data structure and combined with the current forward scores to calculate an overall score for the whole utterance. If the word is not found at the frame, a value not higher than the minimum score is assigned as the overall score.

The method can further include pausing automatic speech recognition in the forward direction when any remaining active hypotheses have scores below a predetermined threshold or when a timeout is reached. Many active hypotheses can be open that have not yet reached a word end. If they had reached a word end, the process would already have dealt with them as described in the previous paragraph. Pausing is employed to abandon the active hypotheses that have not yet gotten there. The scores of these active hypotheses are typically not overall scores, i.e., scores from start of the utterance all the way to utterance end (forward combined with the backwards pass). Since a word end has not been reached, the process has not connected to the backward pass, so the process does not have the overall score yet, but still might want to stop processing low probability hypotheses.

The remaining active hypotheses are the ones that have not yet reached the end of a word, after the initial words that were already confirmed and to which the initial automatic speech recognition (ASR) was restricted. Using a predetermined threshold is useful and may be necessary to avoid an ASR model matching a very long period of audio and, hence, keeping recognition running for too long.

The top n hypotheses (e.g., n-best possible words) according to the full utterance scores (e.g., overall scores for the utterance) can be presented to the external information source for confirmation, selection or correction.

Performing the automatic speech recognition in the forward direction can include linking a forward search space with a subset of the pre-processing data.

In an embodiment, a system for performing bidirectional automatic speech recognition using an external information source is provided. The system includes a memory storing computer code instructions thereon, and a processor. The memory, with the computer code instructions, and the processor being configured to cause the system to perform a precompute pass by a) pre-processing an utterance in a backward direction from end to start of the utterance to generate pre-processing data stored in a data structure; and to perform a run-time pass by b) performing automatic speech recognition on the utterance in a forward direction using the pre-processing data to generate a prediction list that has a given number of words in path probability order; c) (i) presenting a word prediction based on the prediction list to an external information source to obtain a response from the external information source confirming, selecting or correcting the word prediction, (ii) updating the word prediction based on the response from the external information source, and (iii) updating the prediction list accordingly; and d) repeating b) and c) until the end of the utterance is reached. An automatic speech recognized form of the utterance can be output by the system based on the word prediction.

The memory, with computer code instructions, and the processor can be configured further to update a model employed by the automatic speech recognition in the forward direction as a result of the response from the external information source.

The system can include a server and an agent device in communication with the server, in which case the memory includes a server memory and an agent memory, and the processor includes a server processor and an agent processor. The server memory, with the computer code instructions, and the server processor can be configured to cause the server to perform the precompute pass, and the agent memory, with the computer code instructions, and the agent processor can be configured to cause the agent device to perform the run-time pass and to output the automatic speech recognized form of the utterance.

In an embodiment, a non-transitory computer-readable medium including computer code instructions stored thereon for performing bidirectional automatic speech recognition using an external information source is provided. The computer code instructions, when executed by a processor, cause a device (or a system) to perform at least the following: perform a precompute pass by a) pre-processing an utterance in a backward direction from end to start of the utterance to generate pre-processing data stored in a data structure; perform a run-time pass by: b) performing automatic speech recognition on the utterance in a forward direction using the pre-processing data to generate a prediction list that has a given number of words in path probability order; c) (i) presenting a word prediction based on the prediction list to an external information source to obtain a response from the external information source confirming, selecting or correcting the word prediction, (ii) updating the word prediction based on the response from the external information source, and (iii) updating the prediction list accordingly; and d) repeating b) and c) until the end of the utterance is reached; and output an automatic speech recognized form of the utterance based on the word prediction.

The computer code instructions, when executed by the processor, can cause the device (or system) further to update a model employed by the automatic speech recognition in the forward direction as a result of the response from the external information source.

Embodiments may be employed in a system for efficiently creating accurate transcription of spoken audio (utterance) using at least one human editor (agent or other information source) and at least one automatic speech recognition (ASR) engine. The ASR engine can create a hypothesis that the human editor corrects where wrong and such corrections lead to re-evaluation of the ASR hypothesis, recycling partial results from an initial ASR run. Partial results may include a reverse hypothesis structure from the end of the utterance. Re-evaluation can include running ASR forward from a recent correction until a match with the reverse structure is achieved. Correction or confirmation by the human editor is used to update at least one model used in at least one ASR pass to bias recognition. Suitable models can include an acoustic model (AM) that is adapted in supervised fashion, a statistical language model (SLM), or both.

Embodiments have several advantages over prior approaches. A system and associated method for utilizing an external information source(s) for improving ASR accuracy can make optimal use of the external information source (i.e., reduce the human effort that correction requires). This makes processing more efficient, e.g., in terms of time and cost, because less human effort is needed. Purely human transcription is very expensive and slow; thus, embodiments provide possible savings in cost and time. Simple ASR with human correction approaches usually do not achieve any savings in cost or time.

Embodiments can be employed in applications where accurate transcriptions are required in large number of cases, e.g., in (assured) voicemail-to-text (VM2T) service and in transcription services, such as those targeted at the law enforcement market.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram of a system and associated method for collaborative transcription with bidirectional automatic speech recognition according to an example embodiment.

FIG. 2 is a flow chart illustrating a method of performing bidirectional automatic speech recognition using an external information source according to an example embodiment.

FIG. 3 illustrates automatic speech recognition in a forward direction according to an example embodiment.

### DETAILED DESCRIPTION

A description of example embodiments follows.

In transcribing voice data into text, the use of human agents alone may be costly and of poor quality sometimes. For example, the voice data may not always have good audio quality. Further, agents transcribing hours-long voice data may be under strict time constraints. Such factors may result in unsatisfactory transcription results. To address the issues of cost and quality in speech-to-text transcription, computer-based text prediction tools are employed.

A previous approach uses an ASR lattice (word hypothesis graph) to achieve significant efficiency improvements over basic approaches, such as pure human transcription or ASR plus human error correction. The lattice approach, however, has inherent limitations. For example, the lattice size grows exponentially with required increase in oracle accuracy because as the process moves further away in the search space (from the top hypothesis), the multi-dimensionality means the process includes an ever higher proportion of false hits relative to the correct one the process is looking for.

Methods and apparatus of adaptive textual prediction of voice data are described in U.S. Pat. No. 9,099,091 B2, to Topiwala et al., the relevant teachings of which are incorporated herein by reference. This prior approach included adaptation of multiple text prediction sources, including a language model, a lattice decoder, and a human agent.

Running ASR during editing of pre-processed voice data can overcome the above-mentioned limitations of prior ASR lattice approaches. In addition, by allowing the ASR process to learn from already completed segments can improve efficiency further.

Embodiments are useful to solve a general problem, which can be stated as follows:

Some automatic model maps some sequential input to an output. An agent, e.g., a human operator, is incrementally correcting mistakes in the output. The agent, e.g., human operator, is slow and expensive compared to a computer. A task is to feed the human agent's corrections back into the automatic model to improve it and to improve yet un-corrected output before the human agent gets to it.

In a particular use case, ASR converts speech to text. Human agent correction is added while the ASR model is running to change the text output and, optionally, adjust the ASR model.

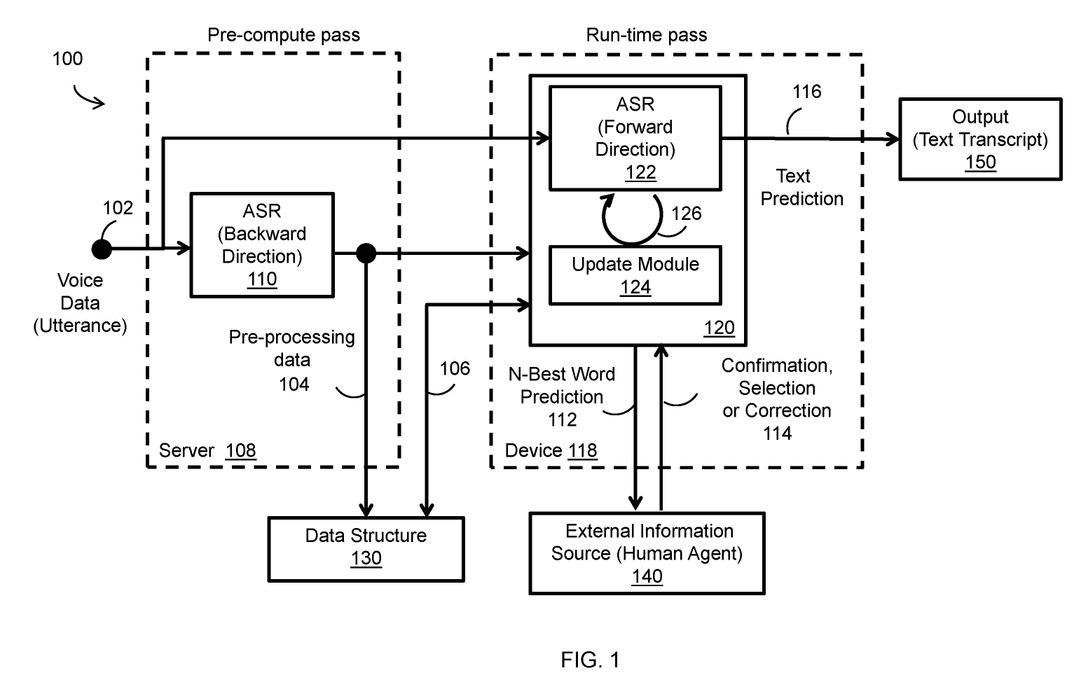

FIG. 1 is a block diagram of a system and associated method for collaborative transcription with bidirectional automatic speech recognition according to an example embodiment. System 100 is configured for performing bidirectional automatic speech recognition of voice data 102 using an external information source 140, e.g., human agent. The system is configured to perform a precompute pass and a run-time pass to generate an output 150. Processing associated with the precompute pass can be performed, at least in part, by a server 108. Processing associated with the run-time pass can be performed, at least in part, by an agent device 118.

As illustrated in FIG. 1, the system 100 includes an ASR module 110 (a run-time ASR module) configured to pre-process the voice data 102, e.g., an utterance, in a backward direction, e.g., from end to start of the utterance, to generate pre-processing data 104 that can be stored in a data structure 130. The system 100 includes collaborative transcription module 120 that communicates with the external information source 140. Module 120 includes an ASR module 122 (a run-time ASR module) and an update model 124. ASR module 122 is configured to perform automatic speech recognition on the voice data 102 in a forward direction using the pre-processing data 104 to generate a prediction list that, in an embodiment, has a given number of words in path probability order. Collaborative transcription module 120 can access the data structure 130 to look up (106) data as needed during the run-time pass, e.g., path scores associated with words or other pre-processing data. Module 120 is configured to present a word prediction 112 based on the prediction list to the external information source 140 to obtain a response 114 from the external information source confirming, selecting or correcting the word prediction. The update module 120 is configured to update the word prediction based on the response from the external information source and to update the prediction list accordingly. ASR in the forward direction and updating can be repeated (126) until the end of the voice data is reached. An automatic speech recognized form of the utterance, e.g., text prediction 116, can be output by the system based on the word prediction. As illustrated, the output 150 can be a text transcript of the utterance.

The update module 124 can be configured to update a model employed by the automatic speech recognition in the forward direction, e.g. by ASR module 122, as a result of the response 114 from the external information source 140.

As noted above, the system 100 and associated method can be implemented in a server 108 and an agent device 118 that is in communication with the server 108. The server 108 can include a server memory and a server processor; the agent device 118 can include an agent processor an agent memory. The server memory, with the computer code instructions, and the server processor can be configured to cause the server to perform the precompute pass, and the agent memory, with the computer code instructions, and the agent processor can be configured to cause the agent device to perform the run-time pass and to output the automatic speech recognized form of the utterance.

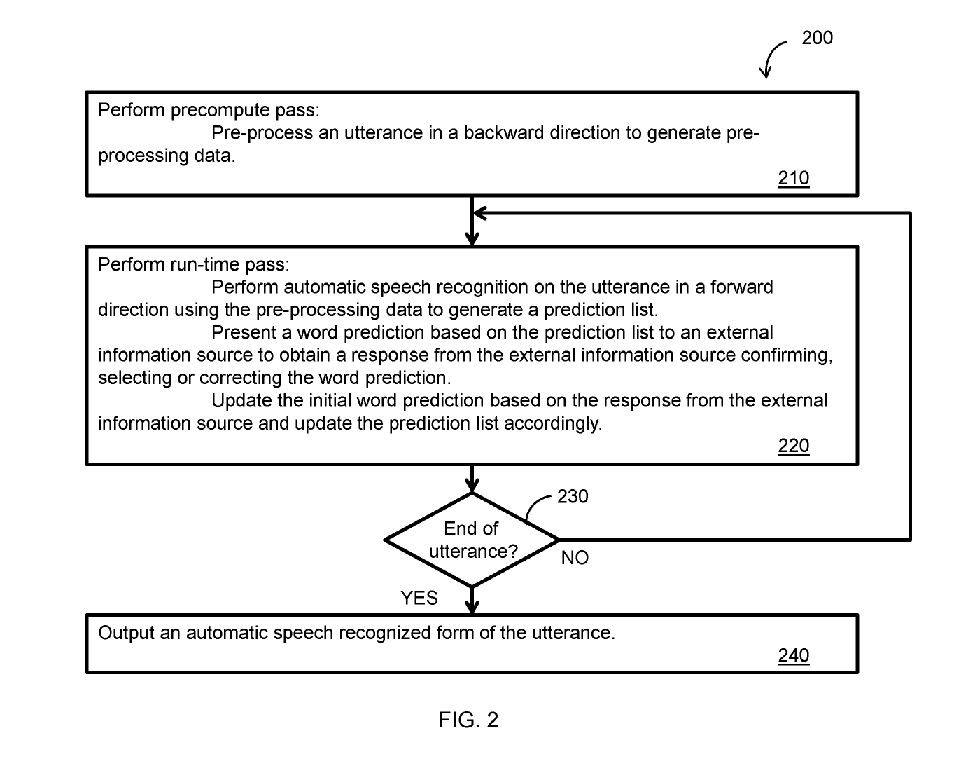

FIG. 2 is a flow chart 200 illustrating a method of performing bidirectional automatic speech recognition on voice data (e.g., an utterance) using an external information source according to an example embodiment. At 210, a precompute pass is performed by pre-processing an utterance in a backward direction, e.g., from end to start of the utterance, to generate pre-processing data, which can be stored in a data structure. At 220, a run-time pass is performed by performing automatic speech recognition on the utterance in a forward direction using the pre-processing data to generate a prediction list. In an embodiment, the prediction list has a given number of words in path probability order. A word prediction based on the prediction list is presented to the external information source to obtain a response. The response from the external information source confirms, selects or corrects the word prediction. The word prediction based on the response from the external information source is updated and the prediction list is updated accordingly. At 230, it is determined whether the end of the utterance is reached. If not, processing of the run-time pass 220 is repeated, e.g., until the end of the utterance is reached. Once the end is reached, an automatic speech recognized form of the utterance is output at 240 based on the word prediction.

The method illustrated in FIG. 2 can be employed in the system of FIG. 1. During the run-time pass (220), performing forward ASR creates an n-best data structure (could be a list or, for instance, a tree) and the external source (e.g., a human agent) either just confirms the best choice, selects the correct choice from the structure or (worst case) types the correct word in. The preferred selection method is to have the human agent keep typing as long as the word is wrong which changes the presented word to the most likely one in the structure that is consistent with the typed characters until the word is right or the end of the word is reached. Other selections methods are also possible, e.g., showing the list and letting the agent point to the correct answer as is known in the art.

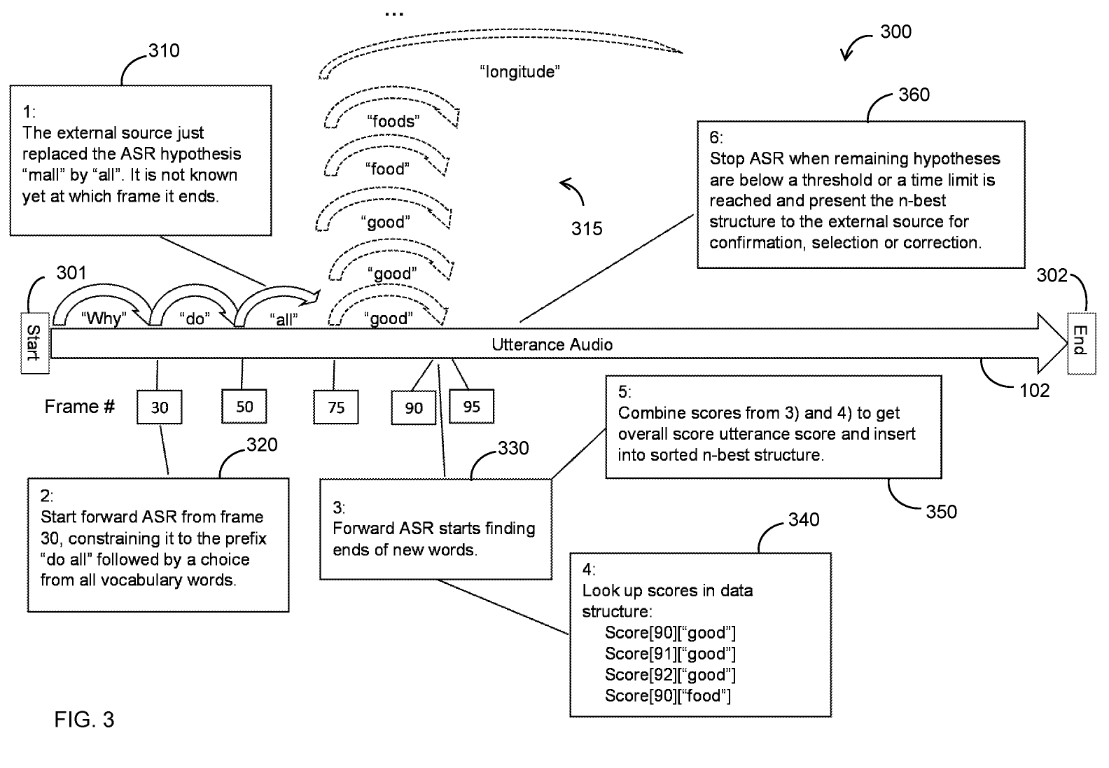

FIG. 3 illustrates automatic speech recognition in a forward direction according to an example embodiment. The figure schematically illustrates a process 300 that may be executed by system 100 during a run-time pass. The process 300 includes a series of procedures (e.g., 310, 320, 330, 340, 350, 360) performed on utterance audio 102. As shown, the audio 102 comprises frames, several of which are indicated, e.g., frame #30, 50, 75, 90 and 95. Processing of the audio, in general, is from start 301 to end 302 of the audio 102. The procedures can be performed in an ordered manner, as indicated by the numbers 1 through 6.

At 310, e.g., procedure number 1, an external source (e.g., source 140 of FIG. 1) just replaced the ASR hypothesis “mall” by “all”. It is not known yet at which frame the word “all” ends. The already confirmed words are “Why,” which ends at frame #30, and “do,” which end at frame #50. When the agent replaced “mall” with “all”, “Why do” were already confirmed but after the agent made the replacement, “Why do all” are now confirmed. So the state of being ‘already confirmed’ is relative to a specific point in time. When the process restarts recognition as described above, “Why do all” were already confirmed in the example (but because it is not known yet when “all” ends, one would want to start recognition at the start of “all” or an earlier word in the “Why do all” sequence).

At 320, e.g., procedure number 2, the process starts forward ASR from frame 30, constraining the ASR to the prefix “do all” followed by a choice from all vocabulary words.

At 330, e.g., procedure number 3, the forward ASR starts finding ends of new words 315, several of which are illustrated, e.g., “good,” “food,” “foods” and “longitude.” In this example, the word “good” is shown three times to illustrate that ASR often hypothesizes several instances with (slightly) different start times.

At 340, e.g., procedure number 4, the process looks up scores in the data structure, e.g., the data structure generated during the pre-processing. In an example data structure, scores and associated words can be stored as follows:
Score[90][“good”]
Score[91][“good”]
Score[92][“good”]
Score[90][“food”]

At 350, e.g., procedure number 5, the process combines scores from 330 (procedure number 3) and 340 (procedure number 4) to get an overall score for the utterance and inserts the score into a sorted n-best structure.

At 360, e.g., procedure number 6, the process can stop ASR when any remaining hypotheses are below a threshold or a time limit is reached. The process can present the n-best structure to the external source for confirmation, selection or correction.

In procedure number 2 of FIG. 3, the ASR process could start later (e.g., at frame 50) or more words back. Also, ASR model adaptation (not shown in FIG. 3) can be employed as described elsewhere herein.

Process could require more than one word overlap between forward ASR and backward path, e.g., could run the forward ASR two words ahead before linking into the pre-calculated best paths. This would allow more accurate estimation of the score to the end of the audio. It would require storing during the backward pass at each frame the score for each word pair ending in this word. The process could then, for instance, look up during the forward pass Score[110][“good”][“things”].

In the first (precompute) pass, the process could also store (per frame and word) the next word (or next n words) in the most likely path so process could show more than one predicted word easily but also enable a more accurate score combination of forward and backward scores (LM rescoring).

### Overview of General Approach

In general, a process of performing bidirectional automatic speech recognition using an external information source, e.g., external human agent, includes two parts: a precompute pass and a run-time pass.

In the precompute pass, the process runs ASR to create rich data structure that enables very fast run-time ASR. The precompute pass can include or be configured to perform one or more of the following:
a. Can run on server;
b. Runs before agent starts correction

In the run-time pass, which is performed in collaboration with the agent, the process runs ASR taking into account current corrected input while using pre-computed data for instant response. The run-time pass can include or be configured to perform one or more of the following:
a. Typically runs on client machine for speed;
b. Agent corrects from left to right;
c. ASR runs after each completed word (accepted or corrected word).

Precompute Pass:

According to an example embodiment, the precompute process runs ASR backward in time and stores for each frame in a “hash table”:

For each word that ends in this frame:
i. (Word_ID as hash key and) the combined acoustic model (AM) and language model (LM) score(s) for best path to the end of the utterance from this frame;
ii. The minimum of the scores in (i).

The process can also store precomputed acoustic parameters, e.g., Mel-Frequency Cepstral Coefficients (MFCCs), bottle neck layer activations or Dynamic Neural Network (DNN) scorer scores.

In an embodiment, the following approximation is used:

Use p(w_1 . . . w_n) approximated by p(w_1 . . . w_m)*p(w_m+1|w_m)*(w_m+2|w_m, w_m+1) . . . p(w_n|w_n−1, . . . , w_n-c),

where:

w_1 . . . w_n is a sequence of words,

n is the (arbitrary) number of words in the sequence,

m is a number less than n,

c is the number of words denoting the length of linguistic context to consider,

p(w_1 . . . w_m) is the linguistic probability of the word sequence w_1 . . . w_m, and

p(w_n−1, . . . ,w_n-c) is the linguistic probability of the word w_n given that the preceding c words in the sequence are w_n−1, . . . ,w_n−c.

Run-time pass:

Using the precomputed path scores during the run-time pass ensures comparable scores (paths to end of utterance) are obtained from the rescoring quickly enough to provide predictions perceived as instant.

The process can run ASR for one word after the already known (approved/corrected) sequence to make use of the full power of the dynamically adapted runtime AM and LM for the immediate prediction. The process can approximate the ASR score for the rest of the recording by looking up the precomputed scores at the relevant frame for the specific word.

The process can start ASR from a word start frame F that the process is confident about, letting F trail behind the currently accepted word to have some realignment flexibility.

ASR preferably runs from the current fixed frame F with LM context LMC and recognition network N consisting of the already known word sequence K followed by all words V in the vocabulary in parallel (no loop).

At some point the process reaches frame F+L_0 where the process starts to hypothesize word ends for some words in V. At this point, the process can look up each of these words in the precomputed hash table at frame F+L_0 and combine the forward score with the backward one (e.g., add them in log space).

If the word is not in the hash table, the process can use the stored minimum value as the estimated remaining path score.

The process can then insert the word into a prediction list PL in path probability order. If the word is already there, only retain the best score. The process keeps doing this for subsequent frames until it runs out of active words.

The process can present the most likely word from the prediction list PL to the agent. The agent either accepts the word or starts typing the correct word. If the agent enters characters, the process can go down the list until it find the first (i.e. most likely) word that matches the character to update the prediction. This continues until the agent accepts the word or indicates word end.

Then the process can update the ASR model(s). This may include, but is not limited to, the following actions:

a) add a word to the vocabulary (if it was missing);

b) update a lexical cache model;

c) incrementally build a document specific LM from the accepted text for interpolation with the original LM;

d) adapt AM parameters utilizing the information gained by aligning the new word with the audio.

After presenting the prediction list to the agent, and, optionally, updating the ASR model(s), the process can run ASR again.

The above process can be implemented according to the following example procedure:

1. F=0, LMC=start, K=zero

2. Run ASR to get PL

3. Offer predictions to agent and get W_1, K=W_1

4. Adapt models and run ASR to get PL

5. Offer predictions to agent and get W_2, K+=W_2

6. F=frame of transition from W_1 to W_2, LMC+=W_1

7. Adapt models and Run ASR to get PL

8. Loop until end of audio
1. Offer predictions to agent and get W_i
2. F=frame of transition from W_i−2 to W_i−1, LMC+=W_i−1, K+=W_i, i+=1
3. Adapt models and Run ASR

The process can employ one or more of the following extensions, alternatives, and optional procedures:

The process can leave the fixed frame trailing further behind to enable more flexibility with re-alignment.

The process can require more than 1 (one) word overlap between forward ASR and backward path, i.e., the process can run the second pass (run-time pass) ASR further ahead before linking into the pre-calculated best paths. This would allow more accurate estimation of the score to the end of the audio. It would also allow showing the agent more than one word prediction.

In the first pass (pre-compute pass), the process could also store (per frame and word) the word ID of the next word (or next n words) in the most likely path so that the process could show the more than one predicted word easily but also enable a more accurate score combination of forward and backward scores (LM rescoring).

The process can use some concept of a “meta frame” to reduce resolution and hence storage and computation at the cost of some precision.

The corrections/selection can in principle come from another knowledge source, not necessarily the human agent (e.g., from an NLU/AI component).

As noted above, adapting models at each process step is optional—it could be done every few steps or not at all.

### Observations and Assumptions About ASR Speech-to-Text Use Case

ASR Accuracy

If ASR is 99% correct, basic correction is efficient and a collaborative approach, such as described here, may not be needed. However, when ASR is <80% correct, correcting its output can become very expensive. This is a use case of interest and for which embodiments are particularly useful.

Comparison to Previous Approach

In the previous approach, an agent traces path through (fixed) decoder search space. A problem with this approach is that 20% of words missing in the search space require 80% of algorithm work to reestablish likely place in search space. One ASR error is seldom alone—errors are usually in clusters. Re-running ASR increases chance of getting next word correct after agent correction.

A simpler and better approach: go back to the speech recognition engine with the new word and ask for updated recognition result. There is no need to re-recognize from start of utterance, just from most recent valid word.

Challenges of the new approach include the speed of predictions after ASR re-start. The big obstacle to overcome in the previous approach was the fact that the correct word was often not in the lattice, requiring heuristics to find the correct alignment with the audio and lattice for new predictions. This case is now handled by calling the speech recognition engine again with the correct word and requesting a new recognition.

According to one hypothesis, the lattice size grows exponentially with required increase in oracle accuracy because as the processing is moving further away in the search space (from the top hypothesis), the multi-dimensionality means that the processing includes an ever higher proportion of false hits to the one correct one that the processes are looking for. This is believed to be an inherent limitation of the lattice approach.

ASR Error Sources

Possible ASR error sources include:

1. Insufficient power of models (no semantics, pragmatics, world knowledge etc.—not fully intelligent);

2. Mismatch of model to data:
a. Wrong pronunciation in lexicon;
b. Production use case not in training data (sufficiently);

3. Search error (correct result was pruned because it did not look promising at some point).

Case 1 listed above typically elicits more chuckles than frowns. It is considered a luxury problem (issue only at high accuracy) and is usually forgiven with the exception of a user's own name, which is rare. The correct answer is likely one of the alternatives in n-best/lattice.

Reverberation, compression, noise, etc. can shift feature space significantly and lead to big errors in case 2 that are very hard to understand for a user. The correct alternative will often not even be in the (pruned) search space.

Search errors can be more common. Thus, case 3 listed above, is considered a more important and common case.

Incremental supervised adaptation of ASR model(s) can have potentially a big effect in these cases. Constraining ASR via agent input is expected to significantly increase chances of correctly recognizing the next word in all cases.

Considerations Regarding Size of Data Stored from First (Precompute) Pass

According to one example, the estimate data storage size is: one score per word (ignoring hash overhead), e.g. 2 bytes per word, 1000 words average=2 kbyte per frame*100 f/s=200 kbyte/second (about 6 times 16 kHz audio PCM)=1.2 MB per minute=72 mbyte per hour. This data amount is large but manageable.

Why run ASR backwards in first (precompute) pass?

Running ASR backwards naturally provides all paths that lead to the end of the utterance, even if the process could not reach the path from the start of the utterance. The updated models used in the second (run-time) pass and/or the agent input can find the path to the start that was not found in the first (precompute) pass.

Running ASR forwards only, may find partial paths from the start of the utterance that may not make it to the end of the utterance, but these paths would have no value in the second (run-time) pass.

Why use trailing recognition start for word chosen from Prediction List?

One could retain the information of the word end frame that was found in the forward pass for this word and start recognition from there, but the next word according to the backwards path that gave the most likely score and hence influenced choosing this frame might not be the best word the forward ASR pass would choose next. Hence, doing so might force an error. Furthermore, running ASR on the newly known word allows the process to adapt the AM. The computational cost of this processing step is very small.

Why employ the first (precompute) pass?

Even with pre-calculating as much as possible, ASR needs information from several words ahead to confidently disambiguate alternatives. For example, after each word, one can rescore vocabulary with LM and audio—but how much audio? Words have different durations but computational procedures (P(w|o)) require comparable observations, i.e., same number of frames. Hence, the ASR typically needs to recognize to the end of the utterance for best results. This is too slow for many user requirements. Using results of the precompute pass, however, the collaborative process described here can provide instant prediction, which is a useful and effective way of attacking the prediction problem.

It should be understood that the example embodiments described above may be implemented in many different ways. In some instances, the various methods and machines described herein may each be implemented by a physical, virtual or hybrid general purpose or application specific computer having a central processor, memory, disk or other mass storage, communication interface(s), input/output (I/O) device(s), and other peripherals. The general purpose or application specific computer is transformed into the machines that execute the methods described above, for example, by loading software instructions into a data processor, and then causing execution of the instructions to carry out the functions described, herein.

As is known in the art, such a computer may contain a system bus, where a bus is a set of hardware lines used for data transfer among the components of a computer or processing system. The bus or busses are essentially shared conduit(s) that connect different elements of the computer system, e.g., processor, disk storage, memory, input/output ports, network ports, etc. that enables the transfer of information between the elements. One or more central processor units are attached to the system bus and provide for the execution of computer instructions. Also attached to the system bus are typically I/O device interfaces for connecting various input and output devices, e.g., keyboard, mouse, displays, printers, speakers, etc., to the computer. Network interface(s) allow the computer to connect to various other devices attached to a network. Memory provides volatile storage for computer software instructions and data used to implement an embodiment. Disk or other mass storage provides non-volatile storage for computer software instructions and data used to implement, for example, the various procedures described herein.

Embodiments may therefore typically be implemented in hardware, firmware, software, or any combination thereof.

In certain embodiments, the procedures, devices, and processes described herein constitute a computer program product, including a computer readable medium, e.g., a removable storage medium such as one or more DVD-ROM' s, CD-ROM's, diskettes, tapes, etc., that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transitory machine-readable medium, which may be read and executed by one or more processors. A non-transient machine-readable medium may include any mechanism for storing or transmitting information in a form readable by a machine, e.g., a computing device. For example, a non-transient machine-readable medium may include read only memory (ROM); random access memory (RAM); magnetic disk storage media; optical storage media; flash memory devices; and others.

Further, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It also should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and, thus, the data processors described herein are intended for purposes of illustration only and not as a limitation of the embodiments.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A method of performing bidirectional automatic speech recognition using an external information source, the method comprising:
performing a precompute pass by:
a) pre-processing an utterance in a backward direction from end to start of the utterance to generate pre-processing data stored in a data structure;
performing a run-time pass by:
b) performing automatic speech recognition on the utterance in a forward direction using the pre-processing data to generate a prediction list that has a given number of words in path probability order;
c) (i) presenting a word prediction based on the prediction list to an external information source to obtain a response from the external information source confirming, selecting or correcting the word prediction, (ii) updating the word prediction based on the response from the external information source, and (iii) updating the prediction list accordingly; and
d) repeating b) and c) until the end of the utterance is reached; and
outputting an automatic speech recognized form of the utterance based on the word prediction.

2. The method of claim 1, wherein the external information source is a human agent.

3. The method of claim 1, wherein the word prediction includes n-best possible words.

4. The method of claim 1, further comprising updating a model employed by the automatic speech recognition in the forward direction as a result of the response from the external information source.

5. The method of claim 4, wherein updating the model includes one or more of adding a word to a vocabulary, updating a lexical cache model, incrementally building a document specific language model from recognized text for interpolation with an original language model, or adapting acoustic model parameters using information gained by aligning a new word with audio data of the utterance.

6. The method of claim 1, wherein pre-processing the utterance in a backward direction includes performing automatic speech recognition on the utterance with a reverse language model.

7. The method of claim 1, wherein the utterance is divided into frames, and wherein the data structure includes, for each frame of the utterance, a path score of a best path to the end of the utterance from the frame.

8. The method of claim 7, wherein the data structure includes, for each word that ends in a given frame, (1) a combined score of acoustic model and language model scores for the best path to the end of the utterance from the frame, and (2) a minimum score of the combined acoustic model and language model scores over all words that end in the frame.

9. The method of claim 8, wherein the data structure further includes acoustic parameters.

10. The method of claim 1, wherein, after updating the word prediction, the automatic speech recognition in the forward direction is performed from a starting point earlier in time than a word start of a word just predicted or confirmed and is initially restricted to a sequence including at least the just predicted or corrected word or more words that have already been confirmed.

11. The method of claim 10, wherein the starting point is selected based on the start time of the first confirmed word in the sequence.

12. The method of claim 10, wherein the automatic speech recognition in the forward direction is performed until one or more ends of new words are hypothesized by the automatic speech recognition.

13. The method of claim 12, further comprising looking up the hypothesized word ends in the data structure to determine, for each of the word ends, whether the word end is found at a given frame in the data structure; and
(i) if the word end is found at the frame, reading relevant scores from the data structure and combining them with the current forward scores to calculate an overall score for the whole utterance;
(ii) if the word is not found at the frame, assigning a value not higher than the minimum score as the overall score.

14. The method of claim 13, further comprising:
pausing automatic speech recognition in the forward direction when any remaining active hypotheses have scores below a predetermined threshold or when a timeout is reached; and
presenting the top n hypotheses according to the overall scores for the whole utterance to the external information source for confirmation, selection or correction.

15. The method of claim 1, wherein performing the automatic speech recognition in the forward direction includes linking a forward search space with a subset of the pre-processing data.

16. A system for performing bidirectional automatic speech recognition using an external information source, the system comprising:
a memory storing computer code instructions thereon; and
a processor,
the memory, with the computer code instructions, and the processor being configured to cause the system to:
perform a precompute pass by:
a) pre-processing an utterance in a backward direction from end to start of the utterance to generate pre-processing data stored in a data structure;
perform a run-time pass by:
b) performing automatic speech recognition on the utterance in a forward direction using the pre-processing data to generate a prediction list that has a given number of words in path probability order;
c) (i) presenting a word prediction based on the prediction list to an external information source to obtain a response from the external information source confirming, selecting or correcting the word prediction, (ii) updating the word prediction based on the response from the external information source, and (iii) updating the prediction list accordingly; and
d) repeating b) and c) until the end of the utterance is reached; and
output an automatic speech recognized form of the utterance based on the word prediction.

17. The system of claim 16, wherein the memory, with computer code instructions, and the processor are configured further to update a model employed by the automatic speech recognition in the forward direction as a result of the response from the external information source.

18. The system of claim 16, wherein the system comprises a server and an agent device in communication with the server, and wherein the memory comprises a server memory and an agent memory, and wherein the processor comprises a server processor and an agent processor, and wherein the server memory, with the computer code instructions, and the server processor are configured to cause the server to perform the precompute pass, and wherein the agent memory, with the computer code instructions, and the agent processor are configured to cause the agent device to perform the run-time pass and to output the automatic speech recognized form of the utterance.

19. A non-transitory computer-readable medium including computer code instructions stored thereon for performing bidirectional automatic speech recognition using an external information source, the computer code instructions, when executed by a processor, cause a system to perform at least the following:
perform a precompute pass by:
a) pre-processing an utterance in a backward direction from end to start of the utterance to generate pre-processing data stored in a data structure;
perform a run-time pass by:
b) performing automatic speech recognition on the utterance in a forward direction using the pre-processing data to generate a prediction list that has a given number of words in path probability order;
c) (i) presenting a word prediction based on the prediction list to an external information source to obtain a response from the external information source confirming, selecting or correcting the word prediction, (ii) updating the word prediction based on the response from the external information source, and (iii) updating the prediction list accordingly; and
d) repeating b) and c) until the end of the utterance is reached; and
output an automatic speech recognized form of the utterance based on the word prediction.

20. The non-transitory computer-readable medium of claim 19, wherein the computer code instructions, when executed by the processor, cause the system further to update a model employed by the automatic speech recognition in the forward direction as a result of the response from the external information source.
